(19) United States
(12) Patent Application Publication
(10) Pub. No.: US 2022/0392398 A1
(43) Pub. Date: Dec. 8, 2022

(54) IMAGE DISPLAY METHOD OF AN IMAGE DISPLAY DEVICE

(71) Applicant: AMERICAN FUTURE TECHNOLOGY, City of Industry, CA (US)

(72) Inventor: You-Chi LIU, City of Industry, CA (US)

(21) Appl. No.: 17/887,364

(22) Filed: Aug. 12, 2022

Related U.S. Application Data
(63) Continuation-in-part of application No. 17/855,342, filed on Jun. 30, 2022.
Application No. 17/855,342 is a continuation-in-part of application No. 17/383,894, filed on Jul. 23, 2021.
Application No. 17/383,894 is a continuation-in-part of application No. 17/091,771, filed on Nov. 6, 2020.

(30) Foreign Application Priority Data
Dec. 4, 2019 (TW) 108144372

(51) Int. Cl. G09G 3/22; B32B 7/023

(52) U.S. Cl. CPC G09G 3/22; B32B 7/023; B32B 2457/20

(57) ABSTRACT

An image display method of an image display device where display units are assembled in an accommodating space inside a base of a light-transmitting material in a stacked shape. The display units each include a light-transmitting board, and display elements are sequentially arranged on the board. There is a control unit on each board, which can control each display element to operate separately or synchronously, and each control unit is respectively electrically connected with at least one signal transmitter and receiver interface located on each board, available for electronic signal transmission with the transmission interface of the host system. The transmission interface is electrically connected to the processor and the processor is electrically connected to the signal input unit, and the electronic signal is transmitted to the display units of the base through the host system, so as to achieve the purpose of displaying static and dynamic images or music.

This application is a Continuation-In-Part of application Ser. No. 17/383,894, filed on Jul. 23, 2021, and application Ser. No. 17/855,342, filed on Jun. 30, 2022; and application Ser. No. 17/383,894, filed on Jul. 23, 2021 is a Continuation-In-Part of application Ser. No. 17/091,771, filed on Nov. 6, 2020; for which priority is claimed under 35 U.S.C. §120, the entire contents of which are hereby incorporated by reference.

This application claims the priority benefit of Taiwan patent application number 108144372, filed on Dec. 4, 2019.

### BACKGROUND OF THE INVENTION

### 1. Field of the Invention

The present invention provides an image display method of an image display device, especially a display device and a display method capable of displaying static and dynamic images and selecting music to be played at the same time. It uses the processor of the host system to select the image electronic signals of the static background and dynamic objects, and transmit it to the plural display units of the base for display, so as to achieve the purpose of displaying static and dynamic images or music.

### 2. Description of the Related Art

When only static or attitude images are played on various display devices connected to the host computer or server, if there is no music playback at the same time, it will be less interesting to watch the images and there is no auditory music to listen to. However, it is slightly insufficient in the application of video playback, and it is not easy to attract users to use various display devices to watch the video.

### SUMMARY OF THE INVENTION

The present invention has been accomplished under the circumstances in view. It is the main object of the present invention to provide an image display method of an image display device, wherein an accommodating space is arranged inside a base made of a light-transmitting material, so that display units are assembled in the accommodating space in a stacked shape. The plural display units include boards made of light-transmitting materials, and plural display elements are sequentially arranged on the surface of the board. There is a control unit on each board, which can control each display element to operate separately or synchronously, and each control unit is respectively electrically connected with at least one signal transmitter and receiver interface located on at least one side of each board, available for electronic signal transmission with the transmission interface of the host system. The transmission interface is electrically connected to the processor and the processor is electrically connected to the signal input unit, and the electronic signal is transmitted to the display units of the base through the host system, so as to achieve the purpose of sequentially displaying or synchronizing static and dynamic images or music.

### BRIEF DESCRIPTION OF THE DRAWINGS

FIG. 1 is an oblique top elevational view of the present invention.

FIG. 2 is a simple block diagram of the present invention.

FIG. 3 is the flow chart of the present invention (I).

FIG. 4 is the flow chart of the present invention (II).

FIG. 5 is the flow chart of the present invention (III).

FIG. 6 is the flow chart of the present invention (IV).

FIG. 7 is the flow chart of the present invention (V).

FIG. 8 is the flow chart of the present invention (VI).

### DETAILED DESCRIPTION OF THE PREFERRED EMBODIMENT

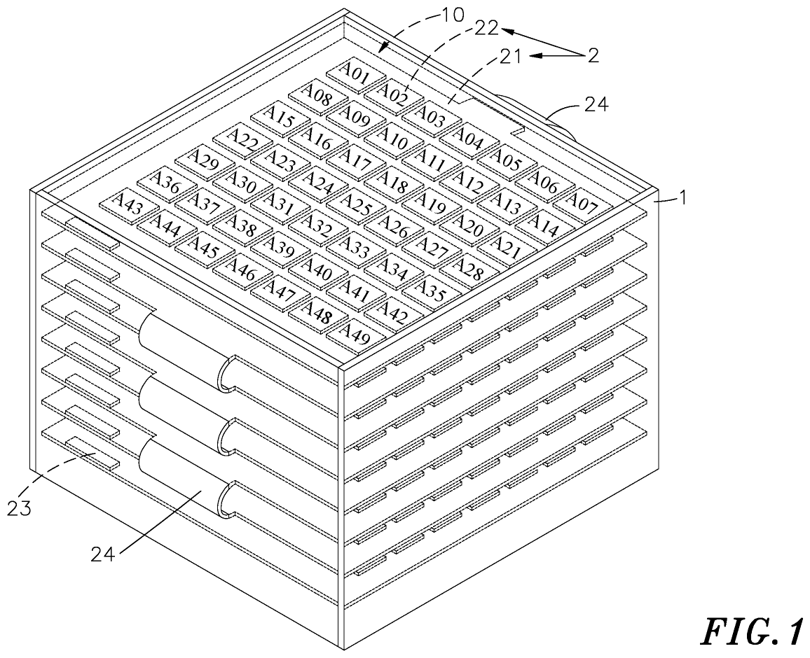

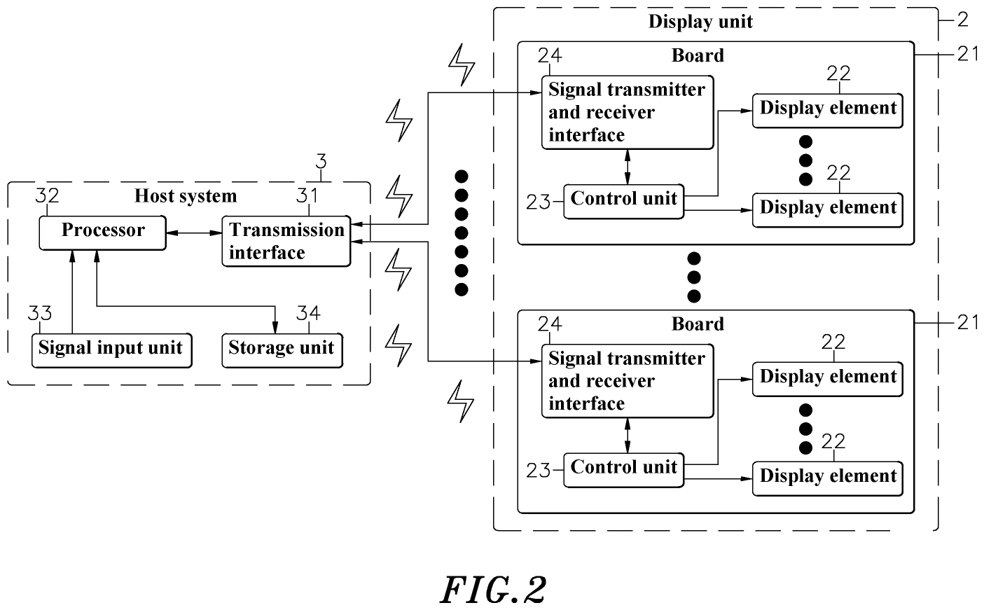

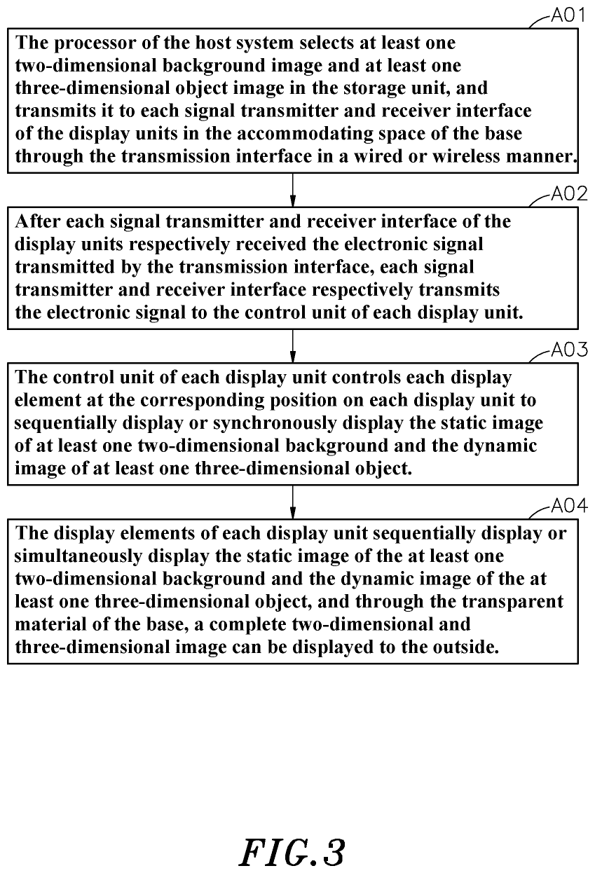

Referring to FIGS. 1-3, as can be clearly seen from the figure, the image display device of the present invention comprises a base 1, a plurality of display units 2 and a host system 3.

The base 1 can be made of light-transmitting material, and there is an accommodating space 10 inside.

The display units 2 are assembled in layers in the accommodating space 10 inside the base 1, each comprising a board 21 made of light-transmitting material, a plurality of display elements 22 arranged on the surface of the board 21 in sequence, a control unit 23 provided on the board 21 to control the operation of each display element 22, and at least one or more than one signal transmitter and receiver interface 24 located on at least one side of the board 21 and electrically connected with the control unit 23 for transmitting electronic signals.

The host system 3 is for electronic signal transmission with the signal transmitter and receiver interfaces 24 of the plurality of display units 2, comprising a transmission interface 31 for electronic signal transmission with the signal transmitter and receiver interfaces 24, a processor 32 electrically connected to the transmission interface 31, a signal input unit 33 electrically connected to the processor 32, and a storage unit 34 electrically connected to the processor 32.

The above-mentioned base 1 can be a rectangular cube, a rectangular cylinder, a cylinder, cone, a pyramid, a hexagonal cube or a polygonal solid made of light-transmitting acrylic, plastic, silicone or rubber materials. The boards 21 of the display units 2 inside the accommodating space 10 in the base 1 can be respectively a sheet-like circuit board made of light-transmitting material such as acrylic, plastic, silicone or rubber. The display elements 22 on the surface of each board 21 can be in the shape of a rectangular array, a circular array, a polygonal array or an irregular shape, etc. The plurality of display elements 22 can be respectively luminescent films, light-emitting diodes or miniature light-emitting diodes, etc., which can be used to sequentially display or simultaneously display at least one or more colors or pictures, etc.

The host system is a computer host or server. Speakers, horns or buzzers are provided in the host system or the display units in the base for playing music. The above-mentioned signal input unit 33 of the host system 3 can be a keyboard, a mouse, or a tablet around the computer for inputting signals.

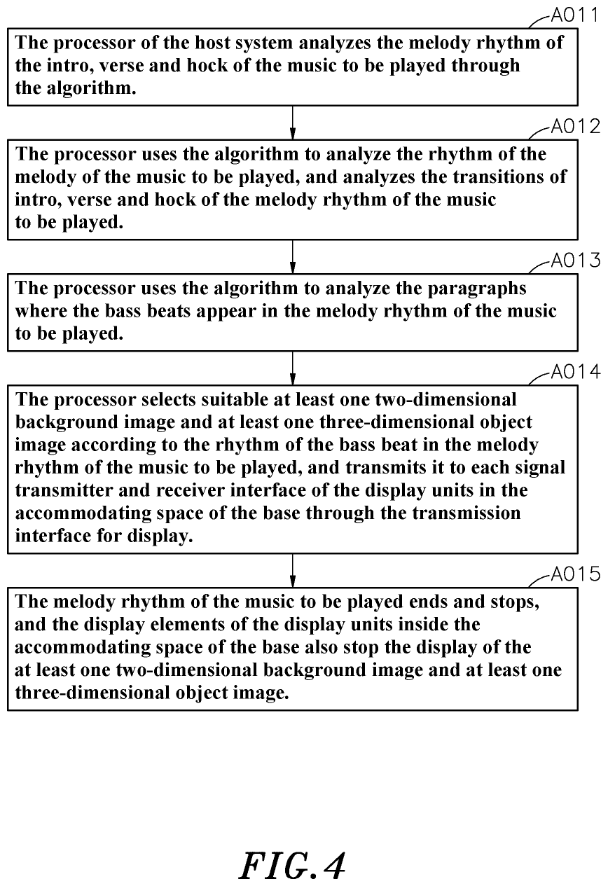

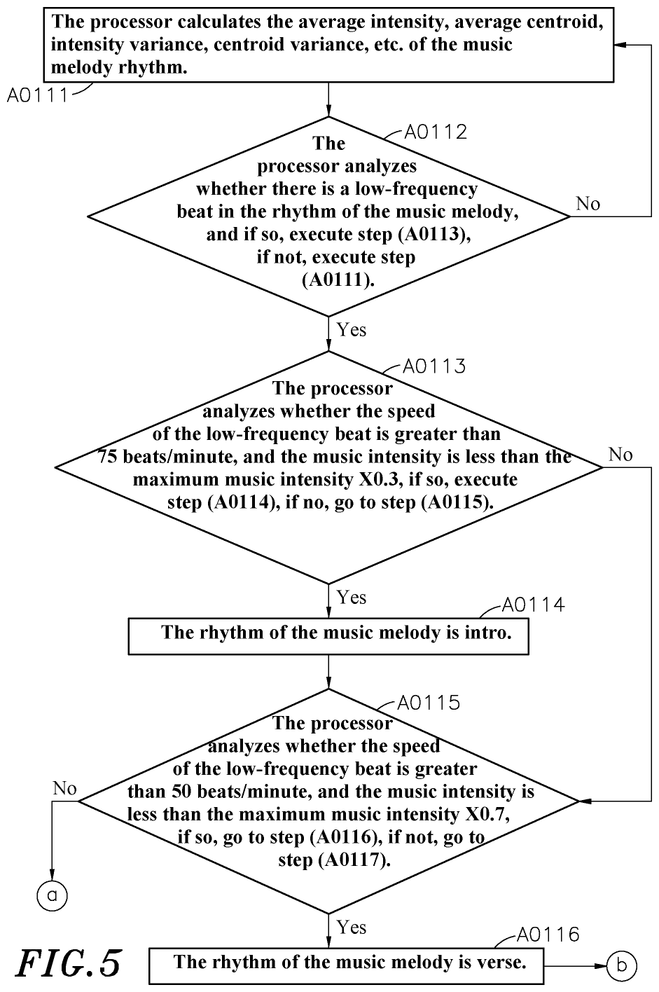

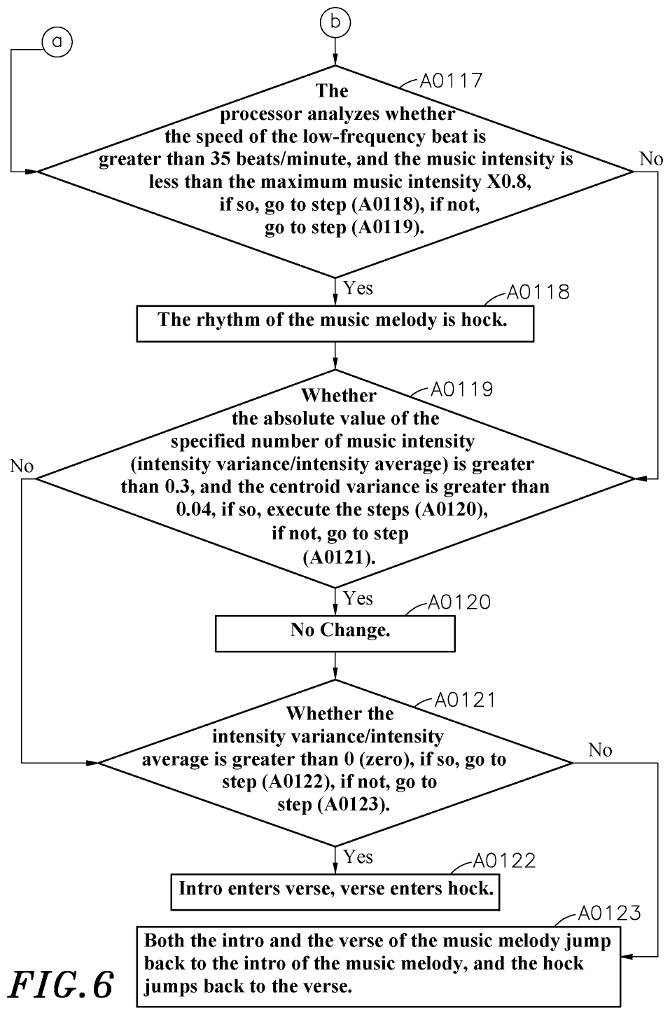

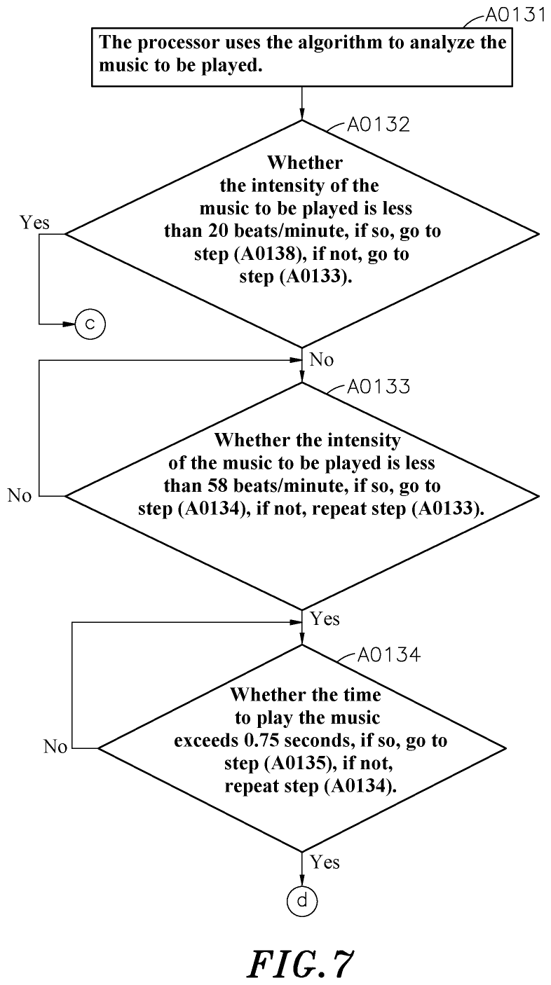

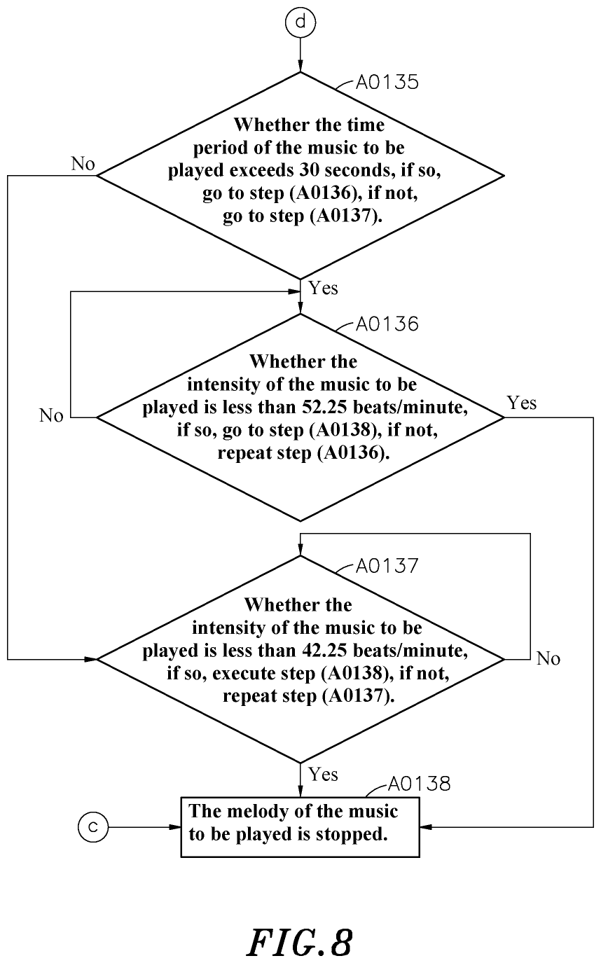

Referring to FIGS. 1-10, the image display method of an image display device comprising the base 1, the display unit 2 and the host system 3 is implemented according to the following steps:

(A01) The processor 32 of the host system 3 selects at least one two-dimensional background image and at least one three-dimensional object image in the storage unit 34, and transmits it to each signal transmitter and receiver interface 24 of the display units 2 in the accommodating space 10 of the base 1 through the transmission interface 31 in a wired or wireless manner.

(A02) After each signal transmitter and receiver interface 24 of the display units 2 respectively received the electronic signal transmitted by the transmission interface 31, each signal transmitter and receiver interface 24 respectively transmits the electronic signal to the control unit 23 of each display unit 2.

(A03) The control unit 23 of each display unit 2 controls each display element 22 at the corresponding position on each display unit 2 to sequentially display or synchronously display the static image of at least one two-dimensional background and the dynamic image of at least one three-dimensional object, or at least one color, etc.

(A04) The display elements 22 of each display unit 2 sequentially display or simultaneously display the static image of the at least one two-dimensional background and the dynamic image of the at least one three-dimensional object, and through the transparent material of the base 1, a complete two-dimensional and three-dimensional image or at least one color can be displayed to the outside.

The host system 3 in the above step (A01) is provided with the storage unit 34 that can pre-store images of multiple two-dimensional backgrounds and images of multiple three-dimensional objects. The images of the plural two-dimensional backgrounds can be pictures, photos or drawings, etc. The three-dimensional objects can be cubes, cuboids, polygons, spheres, rings, tubes, lines, irregular shapes or geometric figures or cartoon shapes, animals, plants, etc.

Each board 21 of each of the display units 2 arranged in stacks in the above-mentioned internal accommodating space 10 of the base 1 uses the signal transmitter and receiver interface 24 to receive the signal transmitted from the transmission interface 31 of the host system 3. Then, each display element 22 on each layered board 21 can sequentially display at least one two-dimensional background image and at least one dynamic image of a three-dimensional object, or at least one or more color changes. Through the processor 32 of the host system 3, the image of the at least one two-dimensional background and the dynamic image of the at least one three-dimensional object are respectively divided into a plurality of blocks vertically, horizontally, etc., and then each block is marked with a relative coordinate position, and then the processor 32 transmits the parsed relative coordinate position signals of the image of the at least one two-dimensional background and dynamic image of the at least one three-dimensional object to each layered board 21.

Through each layered board 21 for the relative coordinate position signal received from the processor 32, the display elements 22 synchronously display the changes of the at least one two-dimensional background image and the dynamic image of the at least one three-dimensional object, or at least one color.

In the host system 3 of the above-mentioned step (A01), the processor 32 can select at least one two-dimensional background image and at least one three-dimensional object image in the storage unit 34, and further select the music to be played, and transmit it to each signal transmitter and receiver interface 24 of the display units 2 inside the accommodating space 10 of the base 1 through the transmission interface 31. The processor 32 of the host system 3 internally stores an algorithm, and the algorithm can be a Fast Fourier transform, etc., so that the algorithm can analyze the transition changes of the melody rhythm of the intro, verse and hock of the music to be played, and then execute the following steps:

(A011) The processor 32 of the host system 3 analyzes the melody rhythm of the intro, verse and hock of the music to be played through the algorithm.

(A012) The processor 32 uses the algorithm to analyze the rhythm of the melody of the music to be played, and analyzes the transitions of intro, verse and hock of the melody rhythm of the music to be played. (A013) The processor 32 uses the algorithm to analyze the paragraphs where the bass beats appear in the melody rhythm of the music to be played.

(A014) The processor 32 selects suitable at least one two-dimensional background image and at least one three-dimensional object image or at least one color, etc. according to the rhythm of the bass beat in the melody rhythm of the music to be played, and transmits it to each signal transmitter and receiver interface 24 of the display units 2 in the accommodating space 10 of the base 1 through the transmission interface 31 for display.

(A015) The melody rhythm of the music to be played ends and stops, and the display elements 22 of the display units 2 inside the accommodating space 10 of the base 1 also stop the display of the at least one two-dimensional background image, at least one three-dimensional object image, or at least one color, etc.

The host system 3 of the above-mentioned steps (A01) to (A04) can be stored in the processor 32 as a built-in algorithm, and the algorithm can be a Fast Fourier transform that can analyze the transition changes of the melody rhythm of the intro, verse and hock of the music to be played. The storage unit 34 of the host system 3 can pre-store multiple two-dimensional background images and three-dimensional object images, etc. The multiple two-dimensional background images can be the images of pictures, photographs or drawings. The three-dimensional objects can be cubes, cuboids, polygons, spheres, rings, tubes, lines, irregular shapes or geometric figures or cartoon figures, animals, plants or flowers.

In the above-mentioned step (A011), the processor 32 of the host system 3 analyzes the melody rhythm of the intro, verse and hock of the music to be played through an algorithm (which is various algorithms such as Fast Fourier transform), and in step (A012), analyzes the transitions of intro, verse and hock of the melody rhythm of the music to be played, the implementation steps are:

(A0111) The processor 32 calculates the average intensity, average centroid, intensity variance, centroid variance, etc. of the music melody rhythm.

(A0112) The processor 32 analyzes whether there is a low-frequency beat (Low frequency is beat) in the rhythm of the music melody, and if so, execute step (A0113), if not, execute step (A0111).

(A0113) The processor 32 analyzes whether the speed of the low-frequency beat is greater than 75 beats/minute, and the music intensity is less than the maximum music intensity X0.3, if so, execute step (A0114), if no, go to step (A0115).

(A0114) The rhythm of the music melody is intro.

(A0115) The processor 32 analyzes whether the speed of the low-frequency beat is greater than 50 beats/minute, and the music intensity is less than the maximum music intensity X0.7, if so, go to step (A0116), if not, go to step (A0117).

(A0116) The rhythm of the music melody is verse.

(A0117) The processor 32 analyzes whether the speed of the low-frequency beat is greater than 35 beats/minute, and the music intensity is less than the maximum music intensity X0.8, if so, go to step (A0118), if not, go to step (A0119).

(A0118) The rhythm of the music melody is hock.

(A0119) Whether the absolute value of the specified number of music intensity (intensity variance/intensity average) is greater than 0.3, and the centroid variance is greater than 0.04, if so, execute the steps (A0120), if not, go to step (A0121).

(A0120) The melody of the music does not change (No Change).

(A0121) Whether the intensity variance/intensity average is greater than 0 (zero), if so, go to step (A0122), if not, go to step (A0123).

(A0122) intro enters verse=verse enters hock.

(A0123) Both the intro and the verse of the music melody jump back to the intro of the music melody, and the hock jumps back to the verse.

In the above steps, 0.3 of (A0113), 0.7 of (A0115), 0.8 of (A0117), and 0.3, 0.04 of (A0119) are all applied parameter values, and when the sound of music is −3 dB, the music intensity (maximum value) is 87 beats/minute, and the music intensity (minimum value) is =90 dB=0 beats/minute. The aforementioned music intensity can be calculated by the formula based on the sound volume of the music, and the formula is a formula used for general music calculation, which is not disclosed here.

The analysis of the timbre of general music is to analyze the spectrum centroid and the frequency bandwidth. The centroid disclosed in the above steps (A0111) and (A0119) is the spectrum centroid. The spectrum centroid represents the overall centroid position of the spectrum distribution. The higher the centroid position is, the higher the frequency of the overall music content or the higher the sound range. In order to perform further spectral analysis on the audio and express the state of the audio at each moment, the audio must be framed first, so that the original signal is cut into many equal-length frames, and a small group of adjacent sample points represents the waveform state of a signal at a certain moment, called a sound frame. N is the number of sound frames, k is the frequency domain sample point of the sound frame, f[k] frequency position is the actual frequency value corresponding to the sample point in the frequency domain of the audio frame, Sₙ[k] represents the nth frame, which corresponds to the spectral intensity of frequency f[k], SC[n] represents the spectrum centroid of the nth frame.

The formula for calculating the spectrum centroid:

$$[ n ] = \frac{{\sum }_{k = 1}^{N / 2 + 1} ( f [ k ] \cdot \vert {S}_{n} [ k ] \vert )}{{\sum }_{k = 1}^{N / 2 + 1} \vert {S}_{n} [ k ] \vert}$$

The formula for calculating the frequency bandwidth:

$$[ n ] = \frac{{\sum }_{k = 1}^{N / 2 + 1} ( f [ k ] - S C [ n ] ) \cdot \vert {S}_{n} [ k ] \vert}{N / 2 + 1}$$

The frequency bandwidth is the weighted average of the difference between each frequency position f[k] and the spectrum centroid SC and the current spectral intensity weight. The larger the frequency bandwidth, the more kinds of musical instruments, and the more dispersed spectral energy is similar to the symphony piece, the smaller the frequency bandwidth is, the more concentrated the similar solo piece.

In this step (A013), the processor 32 utilizes the algorithm to parse the paragraph where the bass beat appears in the melody rhythm of the music to be played, and is executed according to the following steps

(A0131) The processor 32 uses the algorithm to analyze the music to be played.

(A0132) Whether the intensity of the music to be played is less than 20 beats/minute, if so, go to step (A0138), if not, go to step (A0133).

(A0133) Whether the intensity of the music to be played is less than 58 beats/minute, if so, go to step (A0134), if not, repeat step (A0133).

(A0134) Whether the time to play the music exceeds 0.75 seconds, if so, go to step (A0135), if not, repeat step (A0134).

(A0135) Whether the time period of the music to be played exceeds 30 seconds, if so, go to step (A0136), if not, go to step (A0137).

(A0136) Whether the intensity of the music to be played is less than 52.25 beats/minute, if so, go to step (A0138), if not, repeat step (A0136).

(A0137) Whether the intensity of the music to be played is less than 42.25 beats/minute, if so, execute step (A0138), if not, repeat step (A0137).

(A0138) The melody of the music to be played is stopped.

The processor 32 in the above step (A014) uses the built-in algorithm to analyze the intro, verse, interlude, hock and ending in the melody rhythm of the music to be played, and the frequency is high frequency, medium frequency or low frequency.

The three-dimensional objects can be manipulated through different execution programs to appear on the display units 2. The modes can be movement (vertical, horizontal or oblique movement), rotation, scrolling, sliding, dragging, jumping or hiding, and display alternately appearing, etc., and the three-dimensional object mode is a three-dimensional object (for example: cube, cuboid, polygon, sphere, ring, irregular shape or geometric body, etc.). Changes in the number and pattern of different three-dimensional objects appear according to the music to be played, and through the display elements 22 of each board 21 to match the rhythm of the music to be played, different three-dimensional patterns are presented. When listening to music, it also provides the enjoyment of visual senses, presenting a variety of fun of playing music and the enjoyment of multiple additional modes such as hearing and vision, so as to produce unexpected effects.

What the invention claimed is:

1. An image display method of an image display device comprising a base, a plurality of display units and a host system, said base being made of light-transmitting material and defining an accommodating space therein, said display units being assembled in layers in said accommodating space inside said base, each said display unit comprising a board made of light-transmitting material, a plurality of display elements arranged on a surface of said board in sequence, a control unit provided on said board to control an operation of each said display element, and at least one or more than one signal transmitter and receiver interface located on at least one side of said board and electrically connected with said control unit for transmitting electronic signals, said host system is for electronic signal transmission with said signal transmitter and receiver interfaces of said display units, said host system comprising a transmission interface for electronic signal transmission with said signal transmitter and receiver interface, a processor electrically connected to said transmission interface, a signal input unit electrically connected to said processor and a storage unit electrically connected to said processor, the method comprising the steps of:
(A01) said processor of said host system selecting at least one two-dimensional background image and at least one three-dimensional object image in said storage unit, and then transmitting the elected at least one two-dimensional background image and at least one three-dimensional object image to each said signal transmitter and receiver interface of said display units in said base through said transmission interface, said processor of said host system selecting at least one two-dimensional background image and at least one three-dimensional object image in said storage unit and further selecting the music to be played, and then transmitting the elected at least one two-dimensional background image and at least one three-dimensional object image and the selected music to each said signal transmitter and receiver interface of said display units in said base through said transmission interface, said processor of said host system internally storing an algorithm, and the algorithm being a Fast Fourier transform, so that the algorithm is capable of analyzing the transition changes of the melody rhythm of the intro, verse and hock of the music to be played;
(A011) said processor of said host system analyzing the melody rhythm of the intro, verse and hock of the music to be played through said algorithm;
(A012) said processor using said algorithm to analyze the rhythm of the melody of the music to be played, and analyzing the transitions of intro, verse and hock of the melody rhythm of the music to be played;
(A013) said processor using said algorithm to analyze the paragraphs where the bass beats appear in the melody rhythm of the music to be played;
(A014) said processor selecting suitable at least one two-dimensional background image and at least one three-dimensional object image according to the rhythm of the bass beat in the melody rhythm of the music to be played, and transmitting the selected least one two-dimensional background image and at least one three-dimensional object image to each said signal transmitter and receiver interface of said display units in said base through said transmission interface for display;
(A02) after each said signal transmitter and receiver interface of said display units respectively received the electronic signal transmitted by said transmission interface, each said signal transmitter and receiver interface respectively transmits the electronic signal to said control unit of each said display unit;
(A03) said control unit of each said display unit controlling each said display element at the corresponding position on each said display unit to sequentially display or synchronously display the static image of at least one two-dimensional background and the dynamic image of at least one three-dimensional object;
(A04) said display elements of each said display unit sequentially display or simultaneously display the static image of the at least one two-dimensional background and the dynamic image of the at least one three-dimensional object, thereby displaying the complete two-dimensional and three-dimensional images through said base; and
(A015) the melody rhythm of the music to be played being ended and stopped, and said display elements of said display units in said the base also stopping the display of the at least one two-dimensional background image and the at least one three-dimensional object image.

2. The image display method of the image display device as claimed in claim 1, wherein said storage unit of said host system of the step (A01) pre-stores images of a plurality of two-dimensional backgrounds and images of a plurality of three-dimensional objects, said images of a plurality of two-dimensional backgrounds being the images of pictures, photographs or drawings, said three-dimensional objects including cubes, cuboids, polygons, spheres, rings, tubes, lines, irregular shapes or geometric figures or cartoon figures, animals and plants.

3. The image display method of the image display device as claimed in claim 1, wherein in step (A011), said processor of said host system analyzes the melody rhythm of the intro, verse and hock of the music to be played through said algorithm (Fast Fourier transform), and in step (A012), analyzes the transitions of intro, verse and hock of the melody rhythm of the music to be played, the implementation steps are:
(A0111) said processor calculating the average intensity, average centroid, intensity variance and centroid variance of the music melody rhythm;
(A0112) said processor analyzing whether there is a low-frequency beat in the rhythm of the music melody, and if so, executing step (A0113), if not, executing step (A0111);
(A0113) said processor analyzing whether the speed of the low-frequency beat is greater than 75 beats/minute, and the music intensity is less than the maximum music intensity X0.3, if so, executing step (A0114), if no, going to step (A0115);
(A0114) the rhythm of the music melody being intro;
(A0115) said processor analyzing whether the speed of the low-frequency beat is greater than 50 beats/minute, and the music intensity is less than the maximum music intensity X0.7, if so, going to step (A0116), if not, going to step (A0117);
(A0116) the rhythm of the music melody being verse.
(A0117) said processor analyzing whether the speed of the low-frequency beat is greater than 35 beats/minute, and the music intensity is less than the maximum music intensity X0.8, if so, going to step (A0118), if not, going to step (A0119);
(A0118) the rhythm of the music melody being hock.
(A0119) said processor judging whether the absolute value of the specified number of music intensity (intensity variance/intensity average) is greater than 0.3, and the centroid variance is greater than 0.04, if so, executing the steps (A0120), if not, going to step (A0121);
(A0120) the melody of the music does not change (No Change);
(A0121) said processor judging whether the intensity variance/intensity average is greater than 0 (zero), if so, going to step (A0122), if not, going to step (A0123).
(A0122) intro enters verse=verse enters hock.
(A0123) both the intro and the verse of the music melody jumping back to the intro of the music melody, and the hock jumping back to the verse.

4. The image display method of the image display device as claimed in claim 3, wherein the rhythm and timbre of the music are analyzed for the spectral centroid and frequency bandwidth, the formula for calculating the spectrum centroid is:
$$[ n ] = \frac{{\sum }_{k = 1}^{N / 2 + 1} ( f [ k ] \cdot \vert {S}_{n} [ k ] \vert )}{{\sum }_{k = 1}^{N / 2 + 1} \vert {S}_{n} [ k ] \vert}$$
the formula for calculating the frequency bandwidth is:
$$[ n ] = \frac{{\sum }_{k = 1}^{N / 2 + 1} ( f [ k ] - S C [ n ] ) \cdot \vert {S}_{n} [ k ] \vert}{N / 2 + 1}$$
N is the number of sound frames, k is the frequency domain sample point of the sound frame, f[k] is the actual frequency value corresponding to the sample point in the frequency domain of the audio frame, Sn[k] represents the nth frame, which corresponds to the spectral intensity of frequency f[k], SC[n] represents the spectrum centroid of the nth frame.

5. The image display method of the image display device as claimed in claim 1, wherein in step (A013), said processor utilizes the algorithm to parse the paragraph where the bass beat appears in the melody rhythm of the music to be played, and is executed according to the following steps:
(A0131) said processor using the algorithm to analyze the music to be played;
(A0132) said processor judging whether the intensity of the music to be played is less than 20 beats/minute, if so, going to step (A0138), if not, going to step (A0133);
(A0133) said processor judging whether the intensity of the music to be played is less than 58 beats/minute, if so, going to step (A0134), if not, repeating step (A0133);
(A0134) said processor judging whether the time to play the music exceeds 0.75 seconds, if so, going to step (A0135), if not, repeating step (A0134);
(A0135) said processor judging whether the time period of the music to be played exceeds 30 seconds, if so, go to step (A0136), if not, go to step (A0137);
(A0136) said processor judging whether the intensity of the music to be played is less than 52.25 beats/minute, if so, going to step (A0138), if not, repeating step (A0136);
(A0137) said processor judging whether the intensity of the music to be played is less than 42.25 beats/minute, if so, executing step (A0138), if not, repeating step (A0137); and
(A0138) The melody of the music to be played being stopped.
